(19) United States
(12) Patent Application Publication
(10) Pub. No.: US 2025/0369303 A1
(43) Pub. Date: Dec. 4, 2025

(54) ACTUATOR, RECEPTACLE, AND ACTUATOR ASSEMBLY THEREFOR

(71) Applicant: FMC Kongsberg Subsea AS, Kongsberg (NO)

(72) Inventors: Heyn H. Magnus, Kongsberg (NO); Deviprasad Bhat, Kongsberg (NO); Stig Mathisen, Kongsberg (NO); Øyvind Rokne, Kongsberg (NO); Espen Brauti, Kongsberg (NO); Morten Harm, Kongsberg (NO)

(21) Appl. No.: 18/998,653

(22) PCT Filed: Jul. 25, 2023
(86) PCT No.: PCT/EP2023/070527

§ 371 Date: Jan. 27, 2025

(30) Foreign Application Priority Data
Jul. 26, 2022 (NO) 20220829

(51) Int. Cl. E21B 33/035; E21B 33/037

(52) U.S. Cl. CPC E21B 33/0355; E21B 33/037

(57) ABSTRACT

An actuation assembly for a subsea valve is described. The actuation assembly has an actuator with a guide passage and a receptacle with a guide rod which is removably secured within the guide passage of the actuator.

### TECHNICAL FIELD

The present disclosure relates to electric actuators for subsea valves, particularly in the oil and gas industry. More particularly, the present disclosure relates to an actuator assembly for those valves and components that may be used in that assembly, including an actuator, a receptacle and versions of a locking nut.

### BACKGROUND

Valve assemblies known as Christmas (X-mas) trees are assemblies that are used to regulate the flow of fluid from an oil well. They may for example be used to control the flow of oil emanating from the well or to introduce an additive to the flow of oil. There are also valves for controlling flow in manifolds and other subsea structures.

These valve assemblies include actuators that are attached to the valve body and thereby to the X-mas tree or subsea structure, and mechanically connected to a drive element of a valve element located within the tree or other subsea structure. These actuators are conventionally bolted to the X-mas tree or the structure, or attached with one or more clamps.

A technical problem associated with the known clamps is that the clamps are cumbersome and difficult to put in position, especially when a Remotely Operated Vehicle (ROV) is used to position the clamps. This means that when an actuator needs to be replaced or serviced, equipment can often be lost or damaged when the clamps are removed/deployed.

A further technical problem associated with the clamps is that they can be difficult to disengage from the assembly in the case of an emergency.

A further technical problem is that the actuator, as it is made of metal, tends to rust quickly, meaning frequent service/replacement operations are required.

A further technical problem is that, in a subsea assembly, calcium deposits can find their way into gaps and passages of the assembly, making the assembly difficult to disassemble.

### SUMMARY

According to an embodiment of the present disclosure, an actuator for a subsea valve having a guide rod extending therefrom is disclosed. The actuator comprising: an actuator housing; an electric motor located within the actuator housing; a drive mechanism adapted to be driven by the electric motor and engagable with the subsea valve; and a guide element on the actuator housing, the guide element comprising an elongate guide passage for receiving the guide rod, wherein the guide element comprises at least one bracket mounted on the housing and a tube supported by the bracket, wherein the bracket and actuator housing are made of metal and the bracket is mounted on the housing such that electrons may flow from the bracket to the actuator housing.

In embodiments, the guide passage comprises proximal and distal openings, and the distal opening is provided with an inwardly tapered contact surface.

When we refer to “distal and proximal”, we mean with reference to the main body of the subsea valve when the assembly is in use and connected to the main body. For example, the proximal end of the receptacle housing is more proximate the main body of the valve than the distal end of the receptacle housing in use when the proximal end is connected to the main body of the subsea valve.

In embodiments, the actuator comprises a single guide element. This one single guide element has an orientation that is mainly horizontal and that is positioned vertically above the actuator housing when the actuator housing is in an installed position connected to the valve. This gives the possibility of additional guiding of the actuator housing with respect to the valve by gravity.

In embodiments, the actuator housing is, while in an installed position, in electric contact with the X-mas tree or manifold of the other subsea structure, and is protected by the cathodic protection system already installed on that subsea structure.

In embodiments, the elongate guide passage contains a retaining element engageable with a portion of the guide rod.

According to an embodiment of the present disclosure, a receptacle for connecting an actuator to a subsea valve is disclosed. The receptacle comprising: a receptacle housing having proximal and distal ends and an internal chamber, wherein the proximal end is connectable to a body of the valve such that a drive element of the valve is at least partly located in the internal chamber; and the distal end is adapted to receive at least part of a drive mechanism of the actuator such that the drive mechanism and drive element engage within the internal chamber; and a guide rod on the receptacle housing, the guide rod extending parallel to the receptacle housing, wherein the receptacle housing and guide rod are made of metal, and the guide rod is mounted on the receptacle housing such that a current of electrons may flow from the housing to the guide rod. In embodiments, this guide rod may be attached directly to the valve body or subsea structure as such.

In embodiments, the receptacle housing, in an installed position, is in electric contact with the X-mas tree, or manifold of the other subsea structure, and is protected by the cathodic protection system already installed on that X-mas tree or subsea structure.

In embodiments, the guide rod is provided with a threaded portion for engaging a corresponding threaded portion of a locking nut.

In embodiments, the guide rod has a free end remote from the receptacle housing, wherein the threaded portion is a threaded bore that extends longitudinally in the direction of the receptacle housing from the free end.

In embodiments, the receptacle comprises a single guide rod.

In embodiments, the guide rod has an internal passage having an inlet connectable to a source of anti-calcification fluid and at least one outlet on the outer surface of the rod.

In embodiments, the at least one outlet is longitudinally spaced apart from the free end of the rod.

According to an embodiments of the present disclosure, an actuator assembly for a subsea valve is disclosed, comprising: an actuator comprising: an actuator housing; an electric motor located within the actuator housing; a drive mechanism adapted to be driven by the electric motor and engagable with the subsea valve; and a guide element on the actuator housing, the guide element comprising an elongate guide passage; and a receptacle comprising: a receptacle housing having proximal and distal ends and an internal chamber, wherein the proximal end is connectable to a body of the valve such that a drive element of the valve is at least partly located in the internal chamber; and the distal end is adapted to receive at least part of the drive mechanism of the actuator such that the drive mechanism and drive element engage within the internal chamber; and a guide rod on the receptacle housing, the guide rod extending parallel to the receptacle housing and being removably secured within the guide passage of the actuator.

In embodiments, each of the actuator housing, receptacle housing, guide element and guide rod is made of metal, wherein the guide element and guide rod are mounted upon their respective housings and the guide rod secured within the passage such that a current of electrons may flow from the receptacle housing to the actuator housing via the guide rod.

In embodiments, the guide rod has an internal passage having an inlet connectable to a source of anti-calcification fluid and at least one outlet on the outer surface of the rod, and wherein the guide rod is secured within the guide passage such that an annular space is formed between the guide rod and the guide passage, wherein the annular space is in communication with the at least one outlet.

In embodiments, the assembly comprises a locking nut with a threaded portion, wherein the guide rod further comprises a corresponding threaded portion, wherein the threaded portion of the locking nut engages the corresponding threaded portion of the guide rod to removably secure the guide rod within the passage.

In embodiments, the passage has an inlet and an outlet, wherein the guide rod extends through the passage such that a protruding portion of the guide rod extends beyond the outlet of the passage and the locking nut engages the protruding part of the guide rod such that the locking nut bears against the guide element to removably secure the guide rod within the passage.

In embodiments, the guide passage comprises proximal and distal openings and the distal opening is provided with an inwardly tapered contact surface, wherein the locking nut comprises first and second ends and an outwardly tapered contact surface which tapers outwardly from the first end of the locking nut towards the second end of the locking nut, wherein the outwardly tapered contact surface is in contact with the inwardly tapered contact surface.

In embodiments, the guide rod has a free end remote from the receptacle housing, wherein the free end has a threaded bore that extends longitudinally in the direction of the receptacle housing, wherein the threaded bore is the corresponding threaded portion of the guide rod, wherein the locking nut has a threaded element, wherein the threaded element is the threaded portion of the locking nut and the threaded element is adapted to enter and engage with the threaded bore such that the locking nut removably secures the actuator to the guide rod and receptacle.

In embodiments, the threaded element is biased in a first direction.

In embodiments, the guide rod extends into the passage in a forward direction, and the nut engages the guide rod such that the nut presses against a guide contact surface of the guide element which prevents movement of the nut in a rearward direction.

The forward direction extends away from the X-mas tree in use. For example, the whole assembly extends in the forward direction from a proximal end thereof attached to the X-mas tree in use to a distal end thereof. The rearward direction is opposite the forward direction.

In embodiments, the locking nut has a nut bore and the guide rod extends into the nut bore.

In embodiments, the actuator is an actuator.

In embodiments, the receptacle is a receptacle.

In embodiments, a subsea valve comprises an actuator assembly.

In embodiments, the valve is located on a base surface, wherein the guide rod is located above the receptacle housing with respect to the base surface and the guide element is located above the actuator housing with respect to the base surface.

In embodiments, a subsea valve assembly comprises at least one subsea valve.

In embodiments, a locking nut for locking a subsea unit relative to a guide rod fixed to a subsea installation comprises: a body having a bore; and a locking element with a threaded portion, wherein the body has first and second ends, wherein the body includes a tapered contact surface which tapers outwardly from the first end towards the second end.

In embodiments, the locking element is located within the bore and the threaded portion is an externally threaded portion.

In embodiments, the bore extends from an entrance thereof into the body, wherein the entrance is provided at the first end of the body, wherein the locking element is biased within the bore in a first direction by a biasing member towards the entrance of the bore.

In embodiments, the locking element is arranged within the bore such that the locking element can be rotated with respect to the body.

In embodiments, the bore comprises first and second bore portions and a passage that connects the first and second bore portions, wherein a head of the locking element is held within the second bore portion such that axial movement of the head is limited by the second bore portion, wherein the head of the locking element is supported within the second bore portion by a rotatable socket component, wherein the rotatable socket component engages the head of the locking element and the biasing member is held between the socket component and the locking element head such that the biasing element biases the head in the axial direction towards the first bore portion.

In embodiments, the body has a multi-sided profile for interaction with an external tool.

In embodiments, the threaded portion of the locking element defines a screw axis of the locking element, wherein the screw axis of the locking element is co-axial with a bore axis of the bore.

In embodiments, the whole locking element is located within the bore.

In embodiments, an assembly comprises: a subsea unit comprising an elongate passage; a guide rod fixed to a subsea installation and secured within the elongate passage; and a locking nut, a threaded portion of the locking element engaging a corresponding threaded portion of the guide rod such that the tapered contact surface of the nut bears against a corresponding contact surface of the subsea unit and the guide rod is secured within the passage.

In embodiments, the elongate passage has an inlet and an outlet, and the guide rod extends through the elongate passage such that a protruding part of the guide rod extends beyond the outlet, wherein the protruding part of the guide rod comprises the corresponding threaded portion of the guide rod.

In embodiments, a locking nut for locking a subsea unit relative to a guide rod fixed to a subsea installation, comprises: a body with a bore, wherein the body comprises first and second parts which are detachable from one another.

In embodiments, together the first and second parts define the bore.

In embodiments, the body is arranged to split longitudinally when the first and second parts detach from one another.

In embodiments, the body extends between first and second ends thereof, wherein each of the first and second parts extend between the first and second ends of the body.

In embodiments, the body includes a tapered contact surface that tapers outwardly from the first end towards the second end.

In embodiments, the first and second parts are held together with a removable fastening element.

In embodiments, each of the first and second parts have a substantially half cylindrical shape, wherein the first part has a first mating surface and the second part has a second mating surface, wherein the first and second mating surfaces abut one another when the first and second parts are attached, wherein the first mating surface of the first part has a male fastening portion projecting therefrom, and the second mating surface of the second part has a female fastening portion adapted to receive the male fastening portion.

In embodiments, the male fastening portion comprises a first fastening aperture, and the second part comprises a second fastening aperture which connects the female fastening portion with an external surface of the second part, wherein, when the male fastening portion is received in the female fastening portion, the first and second fastening apertures align and the fastening element can be removably secured within the first and second fastening apertures to fasten the first and second parts together.

In embodiments, the fastening element is a pin.

In embodiments, the locking nut comprises a locking element with an externally threaded portion located within the bore.

In embodiments, the bore extends from an entrance thereof into the body, wherein the entrance is provided at the first end of the body, wherein the locking element is biased within the bore in a first direction by a biasing member towards the entrance of the bore. In embodiments, the whole locking element is located within the bore.

In embodiments, the body has a multi-sided profile for interaction with an external tool.

According to an embodiment of the present disclosure, an assembly comprises: a subsea unit comprising an elongate passage; a guide rod fixed to a subsea installation and secured within the elongate passage; and a locking nut engaging the guide rod such that the body of the nut bears against the subsea unit and the guide rod is secured within the passage.

In embodiments, the elongate passage has an inlet and an outlet, and the guide rod extends through the elongate passage such that a protruding part of the guide rod extends beyond the outlet, wherein the locking nut engages the protruding part of the guide rod.

In embodiments, the subsea structure is an X-mas tree and the actuator assembly extends in a mainly horizontal direction from the X-mas tree, wherein a free and distal end of the guide rod is further away from the X-mas tree than a distal end of the actuator housing with respect to the horizontal direction. This provides full access to the locking nut by an ROV.

At least one of the above embodiments provides one or more solutions to the problems and disadvantages with the background art. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment or embodiments.

### BRIEF DESCRIPTION OF THE DRAWINGS

The following drawings illustrate embodiments of the disclosure and serve to explain, by way of example, the principles of the disclosure:

FIG. 1 shows an actuator assembly;

FIGS. 2A and 2B show a sectional view of the actuator assembly of FIG. 1;

FIG. 3 shows an actuator employed in the actuator assembly of FIG. 1;

FIG. 4 shows a receptacle employed in the actuator assembly of FIG. 1 attached to a part of a valve;

FIGS. 5A and 5B show a locking nut, guide element and guide rod of the actuator assembly of FIG. 1;

FIG. 6 shows an anti-calcification arrangement of the assembly of FIG. 1;

FIG. 7 shows the actuator assembly of FIG. 1 attached to a body of a well tree;

FIGS. 8A and 8B show a first locking nut which may be employed in the actuator assembly of FIG. 1;

FIGS. 9A and 9B show a second locking nut which may be employed in the actuator assembly of FIG. 1;

FIGS. 10A and 10B show a third locking nut which may be employed in the actuator assembly of FIG. 1; and

FIGS. 10C and 10D show first and second parts of the locking nut of FIGS. 10A and 10B.

### DETAILED DESCRIPTION

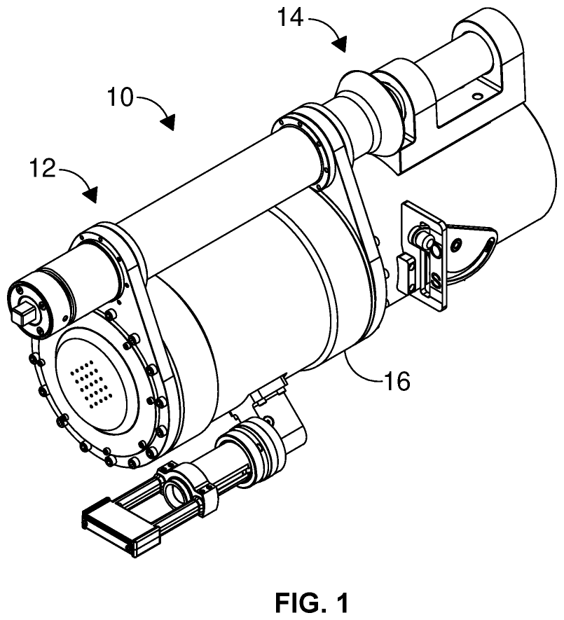

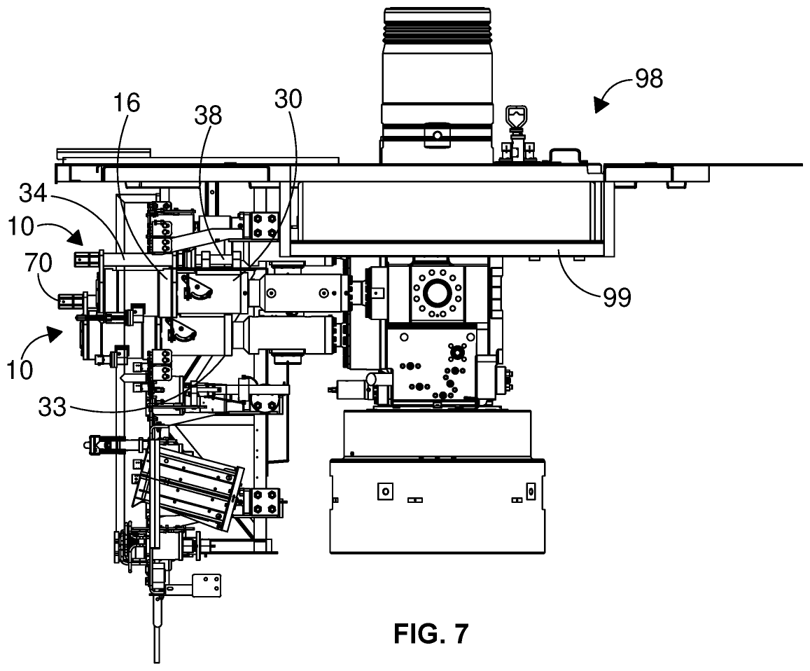

With reference to FIG. 1, there is shown an actuator assembly 10. The actuator assembly 10 is for actuating a valve element of a subsea valve. In FIG. 7, the actuator assembly 10 is shown forming part of a well tree 98 which houses such valve elements.

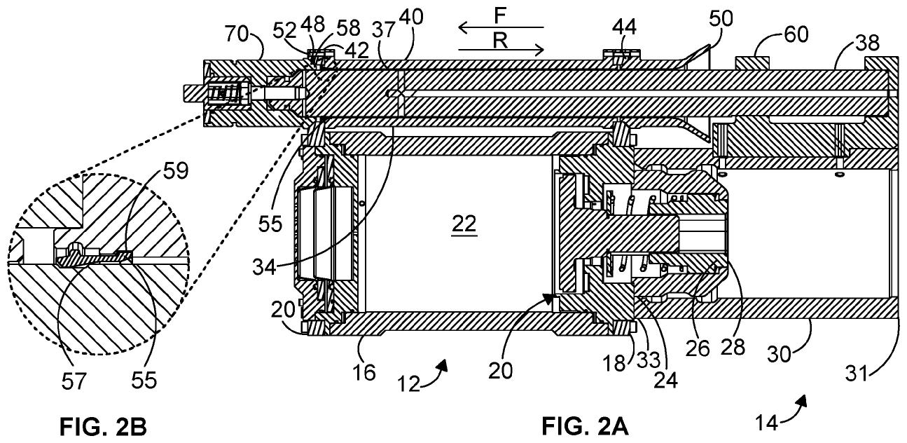

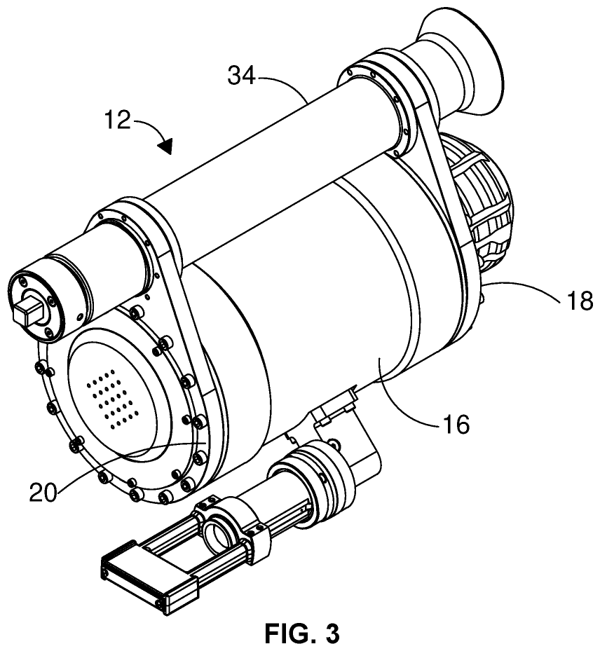

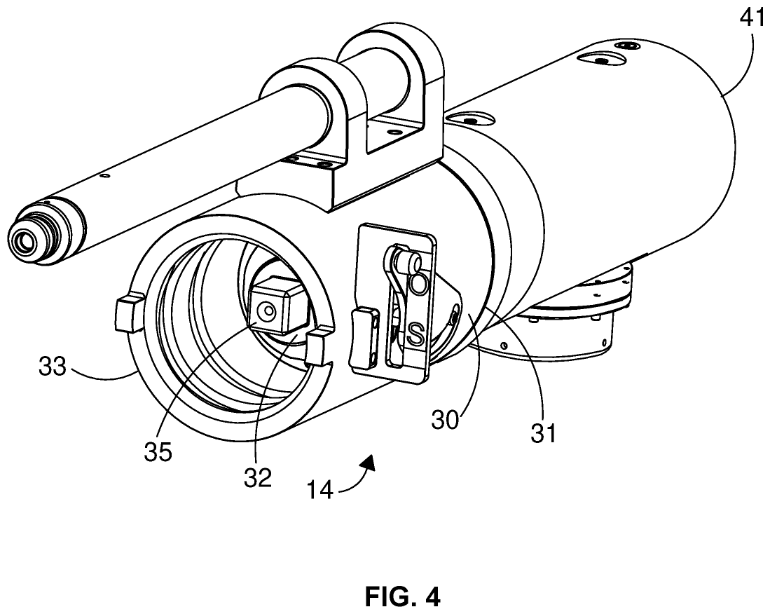

Returning to FIG. 1, the actuator assembly 10 is made up of an actuator 12 and a receptacle 14. The actuator 12 includes an actuator housing 16, which is shown in isolation in FIG. 3. In embodiments, the actuator housing 16 is made of metal. In further embodiments, the actuator housing 16 is made of steel. In embodiments, the actuator housing 16 is substantially tubular and projects between actuator housing proximal and actuator housing distal ends 18, 20. Referring to FIGS. 2A and 2B, the actuator housing 16 includes an actuator space 22 which houses an electric motor (not shown) and a drive mechanism 20 (best shown in FIG. 2A). As depicted, in embodiments, the actuator comprises a head 24 which projects out of the actuator housing 16. In embodiments, inside the head 24 is a rotatable element 26 which has a projection receiving slot 28 that rotates with the rotatable element 26. The electric motor provides a motive force to the drive mechanism 20 such that the rotatable element 26 is rotated.

The receptacle 14, which is shown without the actuator in FIG. 4, includes a receptacle housing 30. In embodiments, the receptacle housing 30 is made of metal. In a further embodiments, the receptacle housing 30 is made of steel. In FIG. 4, the receptacle 14 is shown attached to part of a subsea valve 41. In embodiments, the receptacle housing 30 is substantially tubular and projects between receptacle housing proximal and receptacle housing distal ends 31, 33. The purpose of the receptacle 14 is to connect the actuator 12 with the well tree and optionally to house the mechanical connection between the drive mechanism 20 of the actuator 12 and a drive element of the valve. Part of an example drive element 32 is best shown in FIG. 4. As shown, in embodiments, the drive element includes a cuboidal projection 35 which is received inside the slot 28, and therefore the projection 35 may be rotated by rotatable element 26 when it is driven by the drive mechanism 20. In embodiments, this rotation is translated into a linear motion used to actuate the valve in the tree. In embodiments, the drive element 32 is made up of one or more parts and have one or more motive stages. In use, the receptacle housing distal end 33 abuts the actuator housing proximal end 18.

Referring back to FIG. 2A, located on the actuator housing 16 is a guide element 34. The guide element 34 defines a guide passage 37 for a guide rod 38 located on the receptacle housing 30. As depicted, in embodiments, the guide element 34 comprises a guide tube 40, and first and second brackets 42, 44 which mount the guide tube 40 on the actuator housing. In embodiments, the guide passage 37 extends between proximal and distal openings 50, 52 of the guide element. As shown, in embodiments, the first bracket 42 comprises a bracket aperture 48 which forms the distal opening 52 of the guide element 34, and the passage extends through the bracket aperture and guide tube 40. In embodiments, the bracket aperture 48 tapers inwardly towards the guide tube 40 from the distal opening 52 of the passage so that the bracket has an inwardly tapered contact surface 58. Referring to FIG. 2B, in embodiments, located within the guide passage is a retaining element 55 which is adapted to engage the guide rod. In the depicted example, the retaining element is a snap ring 55 located in a first groove 57 in the guide element 34 and adapted to engage a second groove 59 on the guide rod 38.

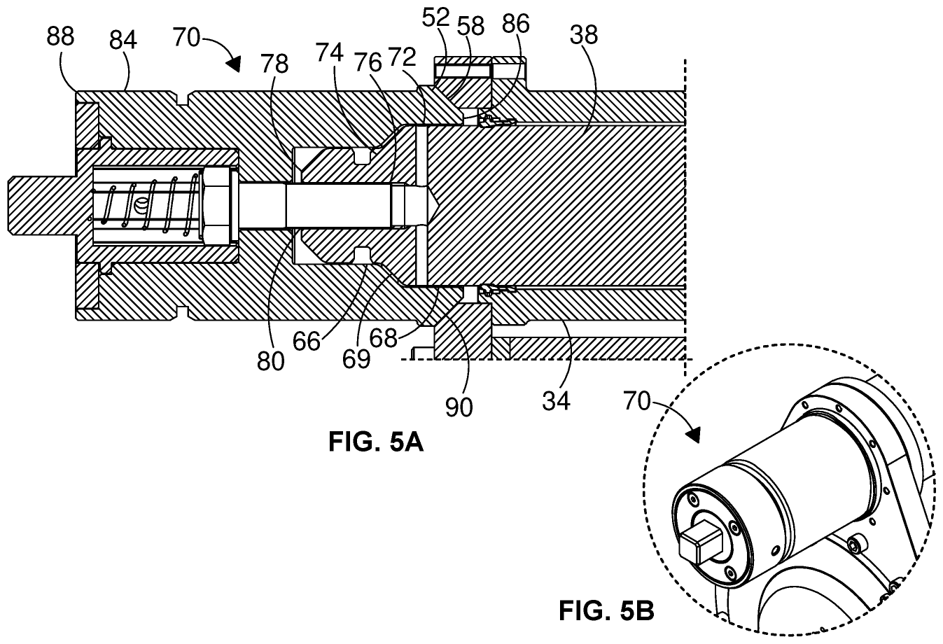

Referring to FIG. 2A, in embodiments, the guide rod 38 is mounted upon the housing by way of a guide mounting bracket 60. The guide rod 38 extends in a forward direction (F) and parallel to the receptacle housing 30 into the guide passage 37. As best shown in FIG. 5A, in embodiments, the guide rod 38 comprises first and second diameter portions 66, 68, where the second diameter portion 68 is located more proximate the guide mounting bracket 60 than the first diameter portion 66, and the second diameter portion 68 is greater than the first diameter portion. An angled surface 69 connects the first and second diameter portions.

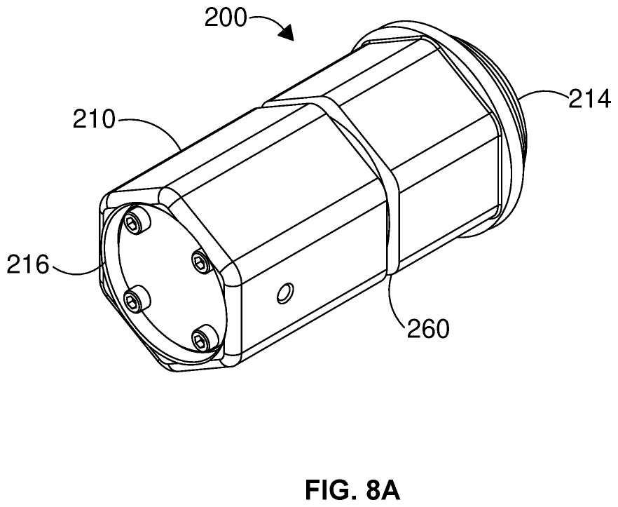

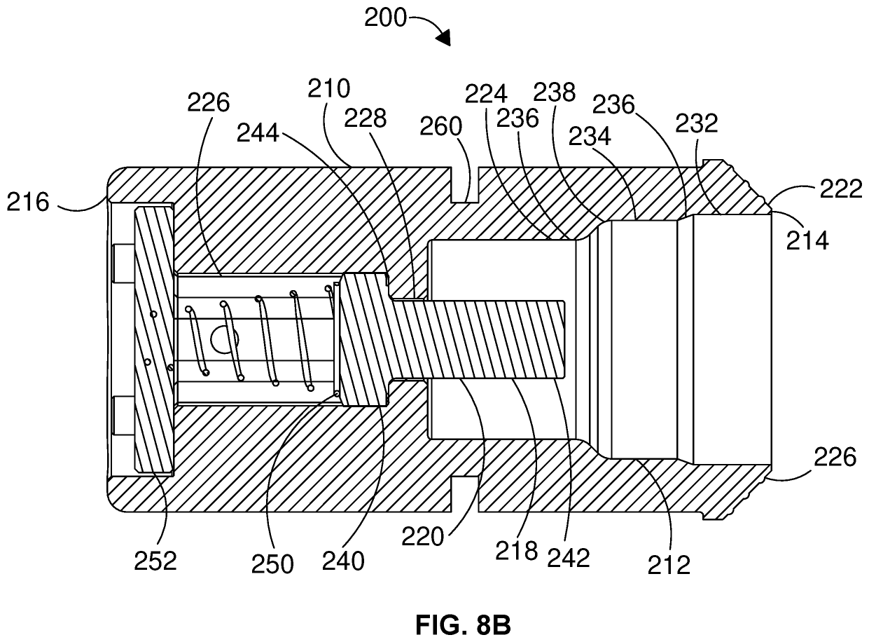

In embodiments, the guide rod 38 is removably secured within the guide passage 37 by a locking nut 70. Three versions of a suitable locking nut will be described below in detail in relation to FIGS. 8, 9 and 10. As shown, for ease of access for an ROV, the locking nut 70 is located at the “front” of the actuator assembly, that is, the end of the actuator assembly which when installed is remote from the valve installation. More specifically, the locking nut 70 engages the guide rod 38 such that it is in contact with a guide contact surface of the guide which limits movement of the nut 70 in a rearward direction (R) (opposite to the forward direction (F)).

As best shown in FIGS. 5A and 5B, in embodiments, this guide contact surface is the inwardly tapered contact surface 58 of the bracket. In embodiments, the guide rod 38 extends through the guide passage 37 into a nut bore 72 of the nut. In a particular embodiment, as shown, a protruding part 74 of the guide rod extends beyond the distal opening 52 of the guide passage, and this protruding part of the guide rod is engaged by the nut 70. In embodiments, the guide rod 38 has a threaded bore 76 that extends from a free end 78 of the guide rod in the rearward direction. In embodiments, the locking nut 70 has a threaded element 80 that engages the threaded bore 76 when the locking nut engages the guide rod. As shown, in embodiments, this threaded element 80 is a locking bolt with an externally threaded portion located in the nut bore 72. In embodiments, the locking bolt is biased within the nut bore 72 in the rearward direction. This allows shocks to be absorbed if the guide rod and locking bolt “bump” into each other during assembly of the actuator assembly. The locking nut 70 has a nut body 84 which extends in the forward direction between first and second ends 86, 88 thereof. In the example shown, the first end 86 is located more proximate the guide element 34 than the second end 88. As shown, in embodiments, the nut body 84 has an outwardly tapered contact surface 90 that tapers outwardly from the first end 86 of the body towards the second end 88 of the body. In the depicted example, the outwardly tapered contact surface 90 is in contact with the inwardly tapered contact surface 58 of the guide. Optionally, the outwardly tapered contact surface 90 is provided with an external thread (not shown), which is arranged to engage a corresponding internal thread provided in the inwardly tapered contact surface 58.

Referring to FIG. 2A, in embodiments, the guide rod 38 and mounting bracket 60 are made of metal and the guide rod mounting bracket 60 is secured to the receptacle housing with tensioned bolts which are also made of metal. In embodiments, the locking nut 70 and bracket 42 are also made of metal. In this way, a current of electrons may flow from the receptacle housing 30 to the actuator housing 16 via the guide rod 38.

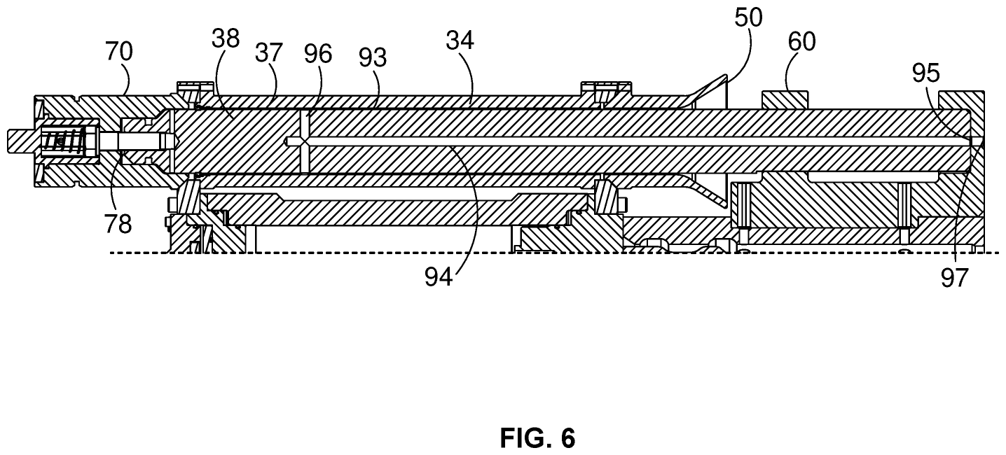

In embodiments, as best shown in FIG. 6, the assembly includes an anti-calcification arrangement. In a particular embodiment, the guide rod 38 is secured within the passage 37 such that an annular space 93 surrounding the guide rod is formed, which is in communication with the proximal opening 50 of the guide passage. As depicted, the distal opening of the guide passage 37 is closed by the locking nut 70. As shown, the guide rod has an internal passage 94 extending therethrough between an internal passage inlet 95 and an internal passage outlet 96. The internal passage outlet 96 is in communication with the annular space 93 and spaced apart from the free end 78 of the guide rod. In embodiments, internal passage inlet 95 is located outside the guide passage and is connectable to a source of anti-calcification fluid (not shown), which may, for example, be citric acid. As depicted, in embodiments, the guide passage extends in the forward direction from the internal passage inlet 95, which is in communication with a mounting bracket aperture 97 provided in the mounting bracket, to a radial portion of the internal passage 94 which extends to the internal passage outlet 96.

As depicted in FIG. 7, the assembly 10 forms part of a subsea valve in use. In the depicted example, the assembly forms part of a well tree 98 and the assembly projects from a body 99 of the well tree. In particular, the proximal end of the assembly (i.e., the receptacle housing proximal end 33) is connected to the body 99, and the assembly projects outwardly from the body 99. The position of the nut 70 at the remote end of the assembly facing away from the body 99 of the well tree 98 means that the assembly can be easily assembled/disassembled by the ROV. In practice, the subsea valve is located on a base surface (not shown), which may be the seafloor or a foundation. In embodiments, the guide rod is located above the receptacle housing with respect to the base surface, and the guide element is located above the actuator housing with respect to the base surface.

With reference to FIGS. 8A and 8B, there is shown a locking nut 200 which may be employed in the assembly of FIG. 1. The nut 200 is for locking a subsea unit relative to a guide rod fixed to a subsea installation, and may be used in the assembly of FIG. 1. The locking nut 200 has a body 210 which defines a bore 212. The bore 212 extends between first and second ends 214, 216 of the body 212. Located within the bore 212 is a locking element 218 with a threaded portion 220. In embodiments, the whole locking element 218 is located within the bore. As shown, in embodiments, the threaded portion 220 of the locking element 218 is an externally threaded portion located in the bore 212. In embodiments, the threaded portion 220 is arranged to engage the threaded bore of the guide rod, as described with reference to FIGS. 5A and 5B. In embodiments, as shown, the locking element 218 is a locking bolt, and the bolt is arranged within the bore 212 such that a screw axis of the locking bolt is co-axial with a bore axis of the bore. The bore axis of the bore 212 is the central axis of the bore.

As shown, in embodiments, the body 210 is elongate, and in particular has a diameter D and a length L (measured between the first and second ends 214, 216), which is at least 2.5 times D. In embodiments, the diameter D is the greatest outer diameter of the body 210 taken along the length L of the body 210.

The body 210 includes an outwardly tapered contact surface 222 which tapers outwardly from the first end 214 towards the second end 216. In the depicted example, the outwardly tapered contact surface 222 is provided with an external thread 226 which is arranged to engage with a corresponding internal thread of an inwardly tapered surface of the guide element. In embodiments, body 210 is formed of metal. In a further embodiment, body 210 is formed of steel. In embodiments, locking element 218 is also formed of metal. In a further embodiment, locking element 218 is formed of steel so that a current may flow between the body 210 and locking element 218.

As shown, in embodiments, the bore 212 includes a first bore portion 224, a second bore portion 226 and a connecting passage 228 which connects the first and second bore portions 224, 226. As shown, the first bore portion 224 extends from a first bore end located at the first end 214 of the body to the connecting passage 228, which extends from the first bore portion 224 to the second bore portion 226. The second bore portion 226 extends from the connecting passage to a second bore end located at the second end 216 of the body. The first bore portion 224 reduces in diameter as it extends from the first bore end to the connecting passage 228. As depicted, in embodiments, the bore 212 have first and second diameter portions 232, 234 where the first diameter portion 232 is located more proximate the first bore end than the second diameter portion 234, and the first diameter portion 232 is greater than the second diameter portion 234. As shown, a first angled surface 236 connects the first and second diameter portions 232, 234. In the depicted example, the first bore portion 224 also includes a third diameter portion 236 which is located further away from the first bore end than the second diameter portion 234 and is less than the second diameter portion. A second angled surface 238 connects the second and third diameter portions 234, 236.

In embodiments, the locking element 218 comprises a head 240 and a shank 242. In embodiments, the head 240 of the locking element 218 is located in the second bore portion 226, and the shank 242 projects from the head into the first portion 224 and comprise the externally threaded portion of the locking element 218. In embodiments, the head 240 of the locking element 218 is pressed against a surface 244 of the body which limits axial movement of the head 240 in the axial direction by a biasing element 250 located in the second bore portion 226. In the depicted example, a coiled spring is employed as the biasing element 250. In embodiments, the biasing element 250 is arranged to press against the head 240 of the locking element 218 in a first direction towards the first end of the body 210. In embodiments, a plate 252 retains the coiled spring 250 in the second bore portion, and the spring 250 is positioned between the head 240 of the locking element 218 and the plate. As shown, the shank 242 of the locking element 218 is non-rotatably engaged with the connecting passage 228 such that the locking element 218 is non-rotatable with respect to the body. In this way, the body 210 and locking element 218 rotate as one when the externally threaded portion engages the threaded bore of the guide.

As shown, in embodiments, the body 210 has a multi-sided profile so that it may be received by a socket tool of the ROV adapted to receive the nut. In embodiments, the outer surface of the nut is provided with a locking recess 260 which is for receiving a corresponding protrusion of the socket tool. In use, the corresponding protrusion is fitted into the recess 260 such that it forms a snap-fit connection with the recess so that the socket tool is connected to the body 210.

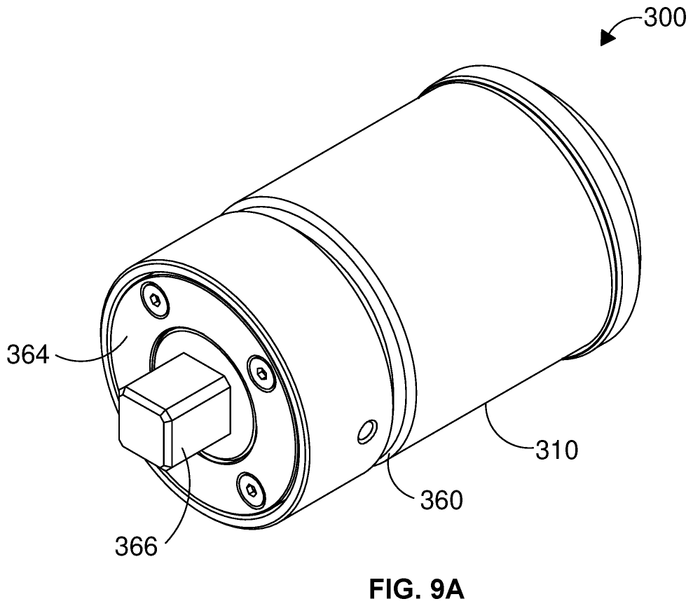

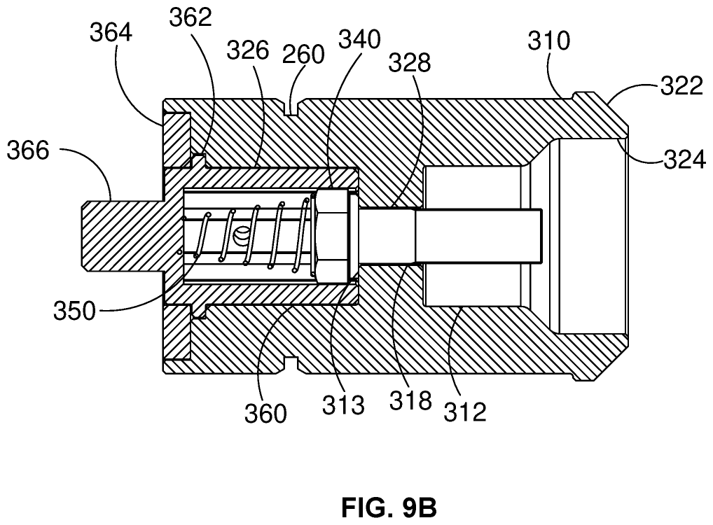

With reference to FIGS. 9A and 9B, there is shown another version of a locking nut 300 which may be employed in the assembly of FIG. 1. The nut 300 of FIGS. 8A and 8B is for locking a subsea unit relative to a guide rod fixed to a subsea installation and may be used in the assembly of FIG. 1.

The locking nut 300 includes a body 310 with a bore 312 and a locking element 318 as described in connection with the locking nut of FIGS. 8A and 8B. As shown, the locking nut has a tapered outer contact surface 322 as described in connection with FIGS. 8A and 8B, although the depicted example does not have an external thread like in the example shown in FIGS. 8A and 8B. As depicted, in embodiments, the locking nut 300 also has a locking recess 260, as described in connection with FIGS. 8A and 8B.

Also, like in the FIGS. 8A and 8B version of the nut, the nut 300 includes first and second bore portions 324, 326 connected by a connecting passage 328, and the head 340 of the locking element 318 is pressed against a limiting surface 313 of the body 310 which defines the second bore portion 326 by a biasing element 350 such that axial movement of the head towards the first bore end of the first bore portion 324 is limited. However, unlike in the locking nut of FIGS. 8A and 8B, the locking element 318 may be rotated independently of the body 310.

As shown, the way in which the head 340 of the locking element 318 is arranged within the second bore portion 326 is also different with respect to the FIGS. 8A and 8B version of the locking nut. In a particular embodiment, the head of the locking element 318 is supported in the bore by a rotatable socket element 360 which has an inner surface adapted to non-rotatably engage the head 340 of the locking element 318, and has an outer cylindrical surface which may rotate within the second bore portion 326. The socket element 360 has an annular flange 362 and the socket element 360 is kept in the bore 312 by a locking ring 364 which abuts the flange and retains the socket element within the bore. The socket element 360 also houses the biasing element 350 which, as described above, presses the head 340 of the locking element 318 against the limiting surface 313. A cuboidal projection 366 projects from the socket element, and the projection may be rotated by a tool to rotate the socket element 360 within the body 310.

Another point of difference with respect to the locking nut 200 of FIGS. 8A and 8B is that the profile of the body 310 of the nut 300 is substantially circular, rather than hexagonal, like in the locking nut 200 of FIGS. 8A and 8B.

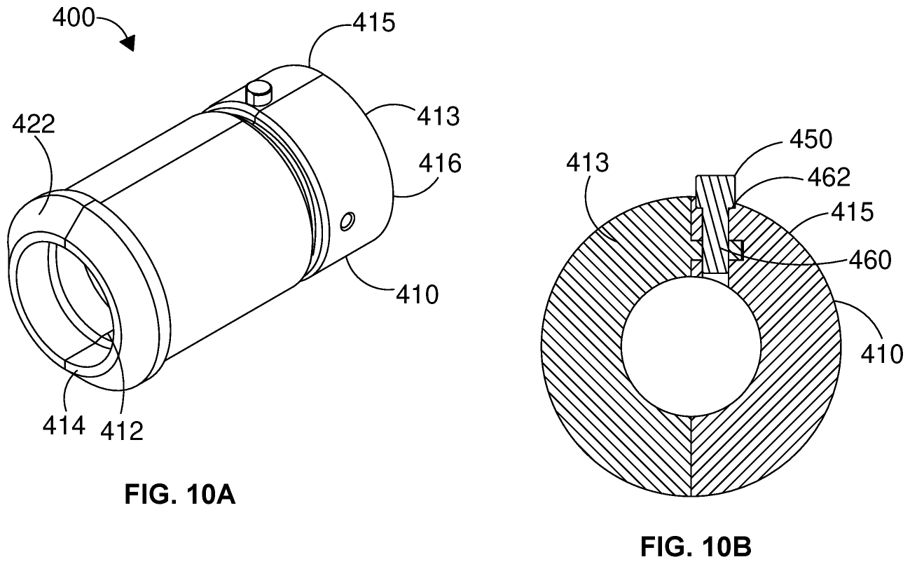

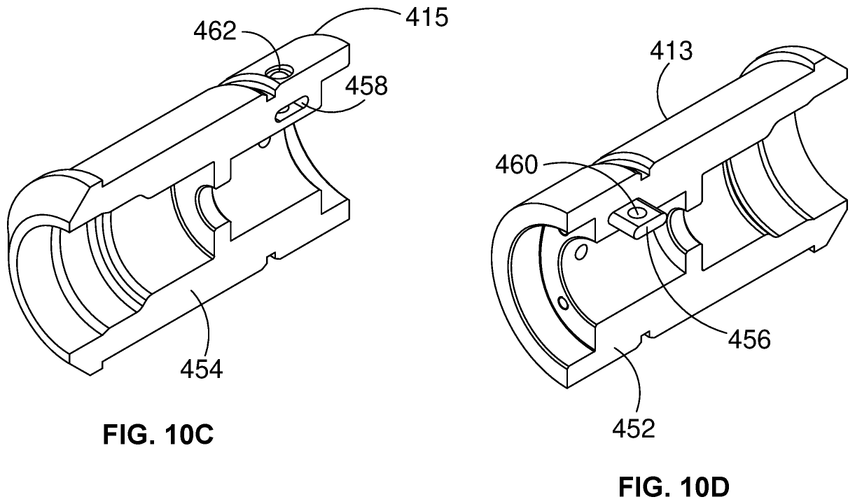

With reference to FIGS. 10A-10D, there is shown a locking nut 400, which may be employed in the assembly of FIG. 1. Like the locking nuts 200, 300 of FIGS. 8A and 8B and FIGS. 9A and 9B, the nut 400 of FIGS. 10A-10D is for locking a subsea unit relative to a guide rod fixed to a subsea installation, and may be used in the assembly of FIG. 1 to secure the guide rod within the passage of the actuator. Also, like the locking nuts 200, 300, the nut 400 of FIGS. 10A-10D has a body 410 with a bore 412. In embodiments, the locking nut 400 also has an outwardly tapering contact surface 422, a locking element with an externally threaded portion, and one or more of the other features of the locking nuts of FIGS. 8A and 8B and FIGS. 9A and 9B.

The locking nut 400 has a body 412 formed of first and second parts 413, 415. The first and second parts 413, 415 of the body 412 are detachable from one another such that, in use, the nut 400 may be split to release the guide rod when it is secured in the passage of the subsea unit. As shown, in embodiments, the body 410 is arranged to split longitudinally when the first and second parts 413, 415 are detached from each other. The body 410 extends between first and second ends 414, 416 thereof. In embodiments, the first and second parts 413, 415 are formed such that they extend between the first and second ends 414, 416 of the body. As shown, in embodiments, together the first and second parts 413, 415 form the bore 412, which is arranged to receive the guide rod in use. In embodiments, the first and second parts 413, 415 are held together with a removable fastening element 450, which, in the depicted example, is a pin.

As best shown in FIGS. 10C and 10D, in embodiments, each of the first and second parts 413, 415 have a substantially half cylindrical shape with first and second mating surfaces 452, 454, respectively. The first and second mating surfaces 452, 454 abut each other when the first and second parts 413, 415 are attached. As shown, the first mating surface 452 has a male fastening portion 456 projecting therefrom, and the second mating surface 454 of the second part 415 has a female fastening portion 458 adapted to receive the male fastening portion 456. In a particular embodiment, as shown, the male fastening portion 456 comprises a first fastening aperture 460, and the second part 415 comprises a second fastening aperture 462 which connects the female fastening portion 458 with an external surface of the second part 415. As shown in FIG. 10B, when the male fastening portion 456 is received in the female fastening portion 458, the first and second fastening apertures 460, 462 align and the fastening element 450 is removably secured within the first and second fastening apertures 460, 462 to fasten the first and second parts together 413, 415. In embodiments, the removable fastening element 450 is secured within the first and second fastening apertures 460, 462 by a threaded or press fit arrangement.

With reference to FIG. 2A, in use, the receptacle 14 is fixed to a subsea valve. When the actuator needs to be replaced/serviced, an ROV first of all disengages the locking nut 70 from the guide rod 38. This is done by unscrewing the locking nut 70 from the guide rod 38. The actuator 12 can then be removed from the receptacle 14 by pulling the actuator 12 forwards. The actuator 12 is then serviced/replaced, and the new or old actuator is put into position by fitting the guide rod 38 into the guide passage 37 of the guide element and arranging the actuator such that the actuator housing proximal end 18 abuts the receptacle housing distal end 33. The locking nut 70 is then aligned with the guide element and is screwed onto the guide rod 38 such that the outwardly tapered contact surface 90 of the nut body abuts the inwardly tapered contact surface 58 of the guide element as shown in FIG. 5A. The guide rod 38 is thus secured within the guide passage 37 by the locking nut and the actuator 12 securely attached to the receptacle 14.

With reference to FIG. 6, when the arrangement is to be “de-calcified”, an anti-calcification fluid such as citric acid is pumped into the internal passage 94 via the internal passage inlet 95. This fluid then fills the annular space 93 and reacts with any calcium deposits such that solid calcium deposits are no longer present within the annular space 93. The fluid exits the annular space 93 via the proximal opening 50 of the guide passage 37.

In embodiments, in use, the locking nuts of FIGS. 8, 9 and 10 engages the guide rod by screwing the locking element 218, 318 with an externally threaded portion of each of these nuts into the threaded bore of the guide rod such that the outwardly tapered surface 222, 322, 422 of the body 210, 310, 410 contacts the inwardly tapered surface of the guide. This is done using an appropriate ROV tool.

In use of the FIG. 8 version of the nut 200, the body 210 of the nut is rotated when the externally threaded portion engages the threaded bore. This is done using an ROV socket tool which is snap-fitted into the locking recess provided on the outer surface of the body.

In use of the FIG. 9 version of the nut 300, the ROV engages the cuboidal projection 366 and turns the cuboidal projection 366 to rotate the locking element 318 and to screw the externally threaded portion into the guide rod.

In use of the locking nut of FIG. 10, when the locking nut 400 is securing the guide rod within the guide passage, if it is desired to remove the guide rod from the guide passage, and it is not possible to disengage the locking nut from the guide rod using a “screwing” motion, the removable fastening element 450 is removed from the body 410 of the locking nut 400 to detach the first and second parts 413, 415 and to split the body longitudinally. This means that the body 410 no longer bears against the guide meaning that the guide rod is free to be removed from the guide passage.

The guide rod and guide arrangement described herein ensures that the actuator can be removed in a safe and controlled way by an ROV in contrast to prior arrangements which employ clamps. This reduces the risk of a failed ROV operation to service/replace the actuator, and the risk of equipment loss.

The specific electrical connection between the receptacle housing and the actuator housing via the guide rod means that electrons from sacrificial metal plates provided on the valve can flow to the actuator housing. This reduces the rate at which the actuator rusts/degrades, and the frequency of servicing/replacement operations.

The internal passage of the guide rod allows an anti-calcification fluid such as citric acid to be pumped into the guide passage ensuring that the guide rod does not become undesirably fixed within the guide passage as a result of calcium deposits.

The tapered contact surfaces on the guide element and locking nut ensure that it is easy to align the nut, guide and rod when the actuator has been assembled, thereby ensuring that the assembly operation has a low risk of failure. The tapered contact surfaces also ensure that there is a strong electrical connection between the locking nut, bracket and guide rod.

In the actuator assembly described herein, the locking nut is positioned at the front, or remoted end, of the assembly. This ensures that the locking nut may be easily accessed by an ROV to dissemble or assemble the actuator assembly.

Each of the locking nuts of FIGS. 8 to 10 is advantageous as it allows the specific assembly shown in FIG. 1 to be fixed in position. In addition, the locking nut allows a strong electrical connection between the tapered contact surfaces on the guide element and guide rod to be formed. The locking element itself may also form part of the flow path for electrons from the guide rod to the actuator housing. The specific locking element with an externally threaded portion is also beneficial because, due to the fact that in practice the locking element has a much smaller diameter than the body, a significant torque can be applied to the locking element, which means it is very easy to “screw” the locking element into the threaded bore of the guide rod.

The specific locking nut of FIG. 9 is advantageous because the body of the nut can remain stationary while the externally threaded portion of the nut is screwed into the threaded bore of the guide rod.

The fact that the specific locking nut is long (i.e., has a length at least 2.5 times its outer diameter) means that the locking nut can be easily secured by the ROV. Also, the locking recess on the outer surface of the nut allows the ROV to easily attach itself to the nut.

The multi-diameter bore of the locking nut also ensures that the locking nut can be easily aligned with the guide rod.

The fact that the locking element within the body of the nut is biased away from the rod receiving end of the bore ensures that the threaded portions of the locking element and guide rod are not damaged if they bump into each other during the assembly operation.

The locking nut of FIG. 10 is advantageous because the first and second parts can be detached from one another in use such that the guide rod is no longer secured within the guide passage by the locking nut. The specific locking nut of FIG. 10 therefore provides an “emergency release” for the system.

The specific position of the guide rod and guide element above their respective housings with respect to the surface upon which the subsea valve is provided upon ensures that the ROV does not need to fight gravity when the ROV is fitting the guide rod into the guide passage.

This written description uses examples to disclose the various embodiments described herein and also to enable any person skilled in the art to practice the various embodiments. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1-24. (canceled)

25. An actuator for a subsea valve having a guide rod extending therefrom, the actuator comprising:
an actuator housing;
an electric motor located within the actuator housing;
a drive mechanism adapted to be driven by the electric motor and engagable with the subsea valve; and
a guide element coupled to the actuator housing, the guide element including an elongate guide passage for receiving the guide rod, the guide element including at least one bracket mounted on the housing and a tube supported by the bracket, the bracket and the actuator housing made of metal, the bracket mounted on the housing such that electrons may flow from the bracket to the actuator housing.

26. The actuator of claim 25, wherein the guide passage comprises a proximal opening and a distal opening, the distal opening provided with an inwardly tapered contact surface.

27. The actuator of claim 25, wherein the actuator comprises a single guide element.

28. The actuator of claim 25, wherein the elongate guide passage contains a retaining element engageable with a portion of the guide rod.

29. A receptacle for connecting an actuator to a subsea valve, the receptacle comprising:
a receptacle housing having a proximal end, a distal end, and an internal chamber, the proximal end configured to connect to a body of the subsea valve such that a drive element of the subsea valve is at least partly located in the internal chamber, the distal end configured to receive at least part of a drive mechanism of the actuator such that the drive mechanism and the drive element engage within the internal chamber; and
a guide rod coupled to the receptacle housing such that a current of electrons may flow from the receptacle housing to the guide rod, the guide rod extending parallel to the receptacle housing, wherein the receptacle housing and the guide rod are made of metal.

30. The receptacle of claim 29, wherein the guide rod is provided with a threaded portion for engaging a corresponding threaded portion of a locking nut.

31. The receptacle of claim 30, wherein the guide rod has a free end remote from the receptacle housing, wherein the threaded portion is a threaded bore that extends longitudinally in the direction of the receptacle housing from the free end.

32. The receptacle of claim 29, wherein the receptacle comprises a single guide rod.

33. The receptacle of claim 29, wherein the guide rod has an internal passage having an inlet connectable to a source of anti-calcification fluid and at least one outlet on the outer surface of the rod.

34. The receptacle of claim 33, wherein the at least one outlet is longitudinally spaced apart from the free end of the rod.

35. An actuator assembly for a subsea valve, comprising:
an actuator including:
an actuator housing,
an electric motor located within the actuator housing, and
a drive mechanism adapted to be driven by the electric motor and engageable with the subsea valve;
a receptacle including:
a receptacle housing having a proximal end, a distal end, and an internal chamber, the proximal end configured to connect to a body of the subsea valve such that a drive element of the subsea valve is at least partly located in the internal chamber, the distal end configured to receive at least part of the drive mechanism of the actuator such that the drive mechanism and the drive element engage within the internal chamber;
a guide element coupled to the actuator housing, the guide element including an elongate guide passage; and
a guide rod coupled to the receptacle housing, the guide rod extending parallel to the receptacle housing and removably secured within the guide passage of the actuator,
wherein the guide element and the guide rod are mounted upon their respective housings, the guide rod secured within the passage such that a current of electrons may flow from the receptacle housing to the actuator housing via the guide rod.

36. The actuator assembly of claim 35, wherein the guide rod has an internal passage having an inlet configured to connect to a source of anti-calcification fluid and at least one outlet on the outer surface of the rod.

37. The actuator assembly of claim 36, wherein the guide rod is secured within the guide passage such that an annular space is formed between the guide rod and the guide passage, wherein the annular space is in communication with the at least one outlet.

38. The actuator assembly of claim 35, wherein the assembly comprises a locking nut with a threaded portion, wherein the guide rod further comprises a corresponding threaded portion, wherein the threaded portion of the locking nut engages the corresponding threaded portion of the guide rod to removably secure the guide rod within the passage.

39. The actuator assembly of claim 38, wherein the passage has an inlet and an outlet, wherein the guide rod extends through the passage such that a protruding portion of the guide rod extends beyond the outlet of the passage and the locking nut engages the protruding part of the guide rod such that the locking nut bears against the guide element to removably secure the guide rod within the passage.

40. The actuator assembly of claim 35, wherein the guide passage comprises a proximal opening and a distal opening, the distal opening provided with an inwardly tapered contact surface, wherein the locking nut comprises a first end, a second end, and an outwardly tapered contact surface that tapers outwardly from the first end of the locking nut towards the second end of the locking nut, wherein the outwardly tapered contact surface is in contact with the inwardly tapered contact surface.

41. The actuator assembly of claim 35, wherein the guide rod has a free end remote from the receptacle housing, wherein the free end has a threaded bore that extends longitudinally in the direction of the receptacle housing, wherein the threaded bore is the corresponding threaded portion of the guide rod, wherein the locking nut has a threaded element, wherein the threaded element is the threaded portion of the locking nut and the threaded element is configured to enter and engage with the threaded bore such that the locking nut removably secures the actuator to the guide rod and receptacle.

42. The actuator assembly of claim 41, wherein the threaded element is biased in a first direction.

43. The actuator assembly of claim 35, wherein the guide rod extends into the passage in a forward direction, and the nut engages the guide rod such that the nut presses against a guide contact surface of the guide element that prevents movement of the nut in a rearward direction.

44. The actuator assembly of claim 43, wherein the locking nut has a nut bore and the guide rod extends into the nut bore.
